(19) United States
(12) Patent Application Publication
(10) Pub. No.: US 2025/0182501 A1
(43) Pub. Date: Jun. 5, 2025

(54) Driver Monitoring Device and Monitoring Program

(71) Applicant: Yazaki Corporation, Tokyo (JP)

(72) Inventor: Kentaro Otomo, Susono-shi (JP)

(21) Appl. No.: 19/044,134

(22) Filed: Feb. 3, 2025

Related U.S. Application Data
(63) Continuation of application No. PCT/JP2023/041362, filed on Nov. 16, 2023.

(30) Foreign Application Priority Data
Dec. 5, 2022 (JP) 2022-194327

(51) Int. Cl. G06V 20/59; G06V 40/10

(52) U.S. Cl. CPC G06V 20/597; G06V 40/10

(57) ABSTRACT

A driver monitoring device includes: an image acquisition unit configured to acquire an image of a driver; and a determination unit configured to determine, based on the acquired image, whether the driver is using a predetermined detection target having no relation with a driving operation. The determination unit extracts, from the image, a first feature point included in a neck or a head of the driver and a second feature point included in an arm or a hand of the driver, and performs processing of determining whether the detection target is included in the image when a difference between a coordinate of the first feature point and a coordinate of the second feature point is smaller than a reference level.

### CROSS-REFERENCE TO RELATED APPLICATIONS

This is a continuation of International Application No. PCT/JP2023/041362 filed on Nov. 16, 2023, and claims priority from Japanese Patent Application No. 2022-194327 filed on Dec. 5, 2022, the entire content of which is incorporated herein by reference.

### TECHNICAL FIELD

The present invention relates to a driver monitoring device and a monitoring program.

### BACKGROUND ART

In recent years, there is a situation in which, for example, due to an amendment to a road traffic act, a new obligation is imposed on a driver who drives a vehicle and the number of new devices that must be mounted on the vehicle increases. For example, a safe driving obligation is imposed on the driver during autonomous driving of the vehicle, and thus it is highly necessary for a system on the vehicle to correctly recognize a driving situation of the driver to support safe driving of the driver, and correctly record an actual situation of the safe driving.

For example, Patent Literature 1 discloses a driver monitoring device capable of detecting a dangerous driving element outside an imaging range of a camera. Specifically, it is described in Patent Literature 1 that inattentive driving is detected by determining an orientation or the like of a face of the driver based on a luminance distribution of the face, and the inattentive driving, drowsy driving, or the like is determined based on a position of a pupil, movement of the pupil, or the like. In addition, it is described in Patent Literature 1 that a smartphone and the like reflected in the pupil on the face or eyeglasses (glasses) can be detected.

### CITATION LIST

### Patent Literature

Patent Literature 1: JP2021-43637A

### SUMMARY OF INVENTION

### Technical Problem

When an in-vehicle system monitors a situation of a driver during driving, a basic function of detecting drowsy driving, inattentive driving, an abnormal posture, and the like is required. Accordingly, it is necessary for the in-vehicle system to accurately grasp information on details of an eye or a face of the driver. For example, a function of detecting a dangerous driving situation such as a case in which the driver is performing distracted driving while operating a smartphone is also required for the in-vehicle system.

However, for example, in a situation in which the driver puts the smartphone on his/her ear and makes a call, the smartphone is not reflected in the pupil or the glasses of the driver, so that presence of the smartphone cannot be detected even using the technique in Patent Literature 1.

In order to implement the functions described above, it is necessary to monitor a state of a detail by constantly capturing, using a camera having a high resolution, an image of a wide range including a body of the driver who is sitting in a driver seat from a location where a blind spot is unlikely to occur, and constantly performing data processing on the captured image, regardless of an actual driving situation. Therefore, a load of a processing device that performs processing on image data and the like becomes very large, and there is a concern that a power consumption increases and a heat generation amount increases.

Since the load of the processing device becomes very large, most of resources of the processing device are constantly consumed, and a situation is conceivable in which the resources of the processing device cannot be used for a purpose other than monitoring the driver. Accordingly, it is difficult to change a design in which a new function is added to the existing processing device.

The present invention has been made in view of the circumstances described above, and an object of the present invention is to provide a driver monitoring device and a monitoring program capable of reducing a processing load of a processing device that processes data such as an image when monitoring a driving situation of a driver.

### Solution to Problem

The object of the present invention is achieved by the following configuration.

A driver monitoring device includes:
an image acquisition unit configured to acquire an image of a driver; and
a determination unit configured to determine, based on the acquired image, whether the driver is using a predetermined detection target having no relation with a driving operation, in which
the determination unit extracts, from the image, a first feature point included in a neck or a head of the driver and a second feature point included in an arm or a hand of the driver, and performs processing of determining whether the detection target is included in the image when a difference between a coordinate of the first feature point and a coordinate of the second feature point is smaller than a reference level.

A driver monitoring device includes:
an image acquisition unit configured to acquire an image of a driver; and
a determination unit configured to determine, based on the acquired image, whether the driver is using a predetermined detection target having no relation with a driving operation, in which
the determination unit detects at least three feature points including a point of a joint position of a body of the driver on the input image, calculates an angle at the joint position based on coordinates of these feature points, and performs processing of determining whether the predetermined detection target is included in the image when the calculated angle satisfies a predetermined condition.

A monitoring program executable by a computer controlling a monitoring device, the monitoring device including an image acquisition unit configured to acquire an image of a driver, and a determination unit configured to determine, based on the acquired image, whether the driver is using a predetermined detection target having no relation with a driving operation, the monitoring program includes:
a procedure of extracting, from the captured image, a first feature point included in a neck or a head of the driver and a second feature point included in an arm or a hand of the driver; and
a procedure of performing processing of determining whether the detection target is included in the image when a difference between a coordinate of the first feature point and a coordinate of the second feature point is smaller than a reference level.

### Advantageous Effects of Invention

According to the driver monitoring device and the monitoring program of the present invention, it is possible to reduce a processing load of a processing device that processes data such as an image when monitoring a driving situation of a driver.

The present invention has been briefly described above. Details of the present invention can be clarified by reading modes (hereinafter, referred to as “embodiments”) for carrying out the invention to be described below with reference to the accompanying drawings.

### BRIEF DESCRIPTION OF DRAWINGS

FIG. 1 is a block diagram showing a configuration of a driver monitoring device according to an embodiment of the present invention.

FIG. 2 is a block diagram showing details of main parts of the driver monitoring device shown in FIG. 1.

FIG. 3 is a front view showing two types of captured images.

FIG. 4 is a front view showing two types of captured images.

FIG. 5 is a flowchart showing an operation example 1 of the main parts of the driver monitoring device shown in FIG. 1.

FIG. 6 is a front view showing two types of captured images.

FIG. 7 is a front view showing two types of captured images.

FIG. 8 is a flowchart showing an operation example 2 of the main parts of the driver monitoring device shown in FIG. 1.

### DESCRIPTION OF EMBODIMENTS

A specific embodiment of the present invention will be described below with reference to the drawings.

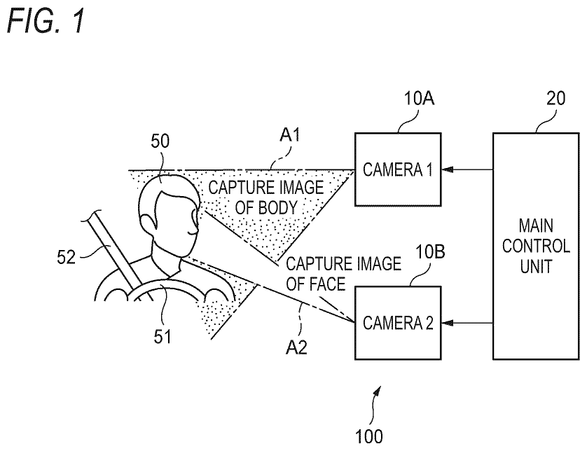

FIG. 1 is a block diagram showing a configuration of a driver monitoring device 100 according to an embodiment of the present invention.

The driver monitoring device 100 shown in FIG. 1 includes a first camera (camera 1) 10A, a second camera (camera 2) 10B, and a main control unit 20.

An installation position and an angle of view of the first camera 10A are adjusted in advance such that an image in an imaging range A1 in FIG. 1 can be captured. That is, the first camera 10A can capture an image in a relatively wide range including a face, an upper half body of a body, an arm, a hand, and the like of a driver 50 who is sitting in a driver seat.

For example, the first camera 10A is installed in a portion of any one of an overhead module, a rear-view mirror, a center portion of an instrument panel, a pillar, a meter hood, an inside of a meter, a steering column, and the like in a vehicle compartment of a vehicle.

The imaging range A1 includes a region in which in-vehicle devices such as a steering wheel 51 and a seat belt 52 of the vehicle is present.

An installation position and an angle of view of the second camera 10B are adjusted in advance such that an image in an imaging range A2 in FIG. 1 can be captured. That is, the second camera 10B can capture an image in only a range that is relatively narrower than that of the first camera 10A such that detailed information on a portion of the face of the driver 50 who is sitting in the driver seat can be captured.

The installation position of the second camera 10B may be a location that is the same as that of the first camera 10A, but it is desirable to dispose the second camera 10B at a position where the image can be captured from a front side of the driver 50 so as to more easily acquire information such as a line of sight.

The number of cameras used by the driver monitoring device 100 may be one, or may be increased to three or more as necessary.

The main control unit 20 is an electronic control unit (ECU) having a function of monitoring a situation of the driver based on images captured by the first camera 10A and the second camera 10B. The main control unit 20 can control, for each of the first camera 10A and the second camera 10B, a timing of capturing the image, a timing of acquiring image data, an exposure amount, a gain, and the like. The main control unit 20 processes the image data acquired from at least one of the first camera 10A and the second camera 10B to acquire information indicating a driving situation, automatically records and stores the resulting information, and performs output of an alarm, and the like depending on the situation in order to support safe driving.

### Main Functional Configuration

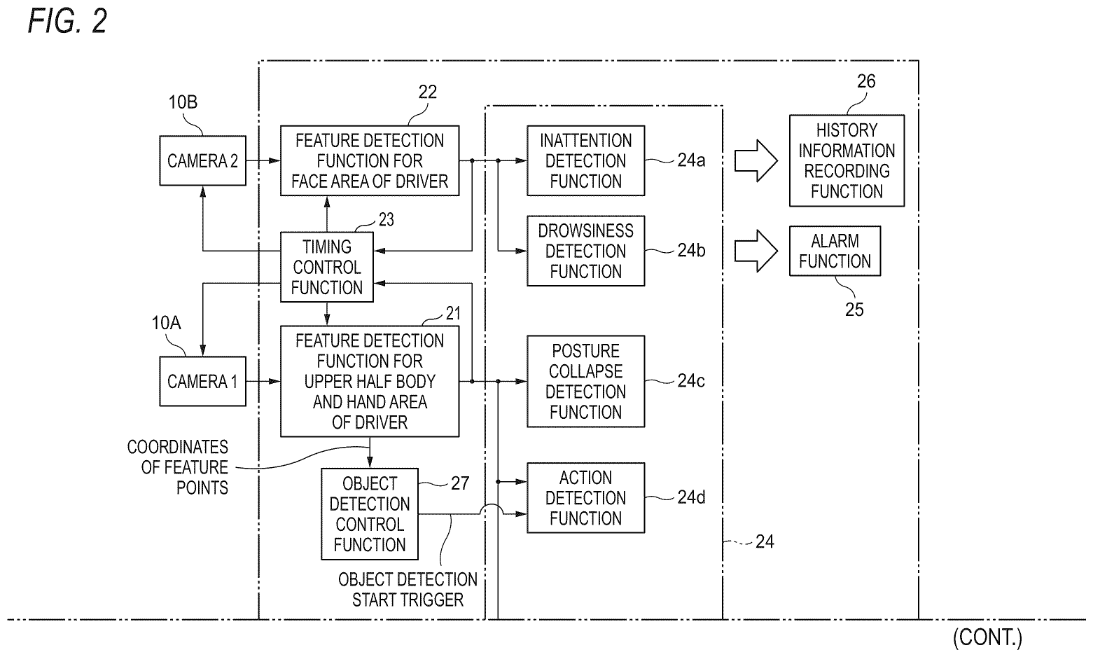

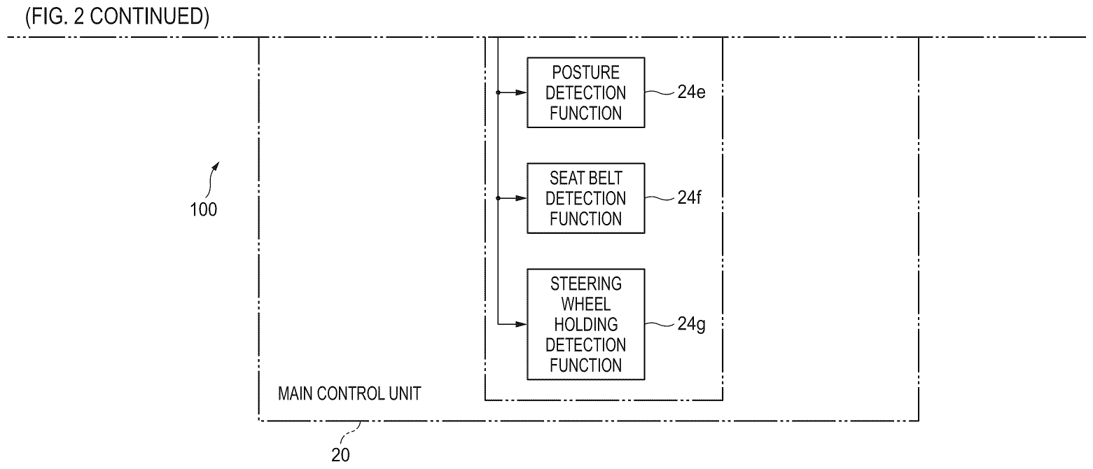

FIG. 2 is a block diagram showing details of main parts of the driver monitoring device 100 shown in FIG. 1.

Each of functions of the main control unit 20 shown in FIG. 2 is implemented by, for example, an operation of hardware of an electronic circuit that mainly includes a microcomputer (not shown) incorporated in the main control unit 20 and a program executed by the 25 microcomputer.

As shown in FIG. 2, the main control unit 20 includes feature detection functions 21 and 22, a timing control function 23, a monitoring function unit 24, an alarm function 25, a history information recording function 26, and an object detection control function 27. The monitoring function unit 24 includes an inattention detection function 24a, a drowsiness detection function 24b, a posture collapse detection function 24c, an action detection function 24d, a posture detection function 24e, a seat belt detection function 24f, and a steering wheel holding detection function 24g.

The feature detection function 21 detects various features of each part of the upper half body and a hand area of the driver 50 by performing image processing on the image data acquired from the first camera 10A. The feature detection function 22 detects various features of a face area of the driver 50 by performing image processing on the image data acquired from the second camera 10B.

The timing control function 23 can control, based on a detection state of each of the feature detection functions 21 and 22, a timing at which each of the first camera 10A and the second camera 10B performs imaging (including control of illumination light), a timing at which each of the first camera 10A and the second camera 10B transmits the captured image data to the main control unit 20 (or a timing at which the main control unit 20 requests the image), and the like.

The monitoring function unit 24 detects a current state of each of various monitoring target items required in the vehicle.

The inattention detection function 24a has a function of detecting, based on information on the face of the driver 50, whether the driver 50 is driving in a state of facing a direction that has no relation with the driving.

The drowsiness detection function 24b has a function of detecting, based on the information on the face of the driver 50, whether the driver 50 is driving in a state in which eyes of the driver 50 are closed or in a drowsy state.

The posture collapse detection function 24c has a function of detecting, based on information on the upper half body of the body and the like of the driver 50, whether the driver 50 is driving in an abnormal posture different from a normal driving posture.

The action detection function 24d has a function of detecting, based on the information on the upper half body of the body and the like of the driver 50, whether the driver 50 is performing a dangerous “distracted driving” action such as operating a smartphone.

The posture detection function 24e has a function of detecting information such as a posture of the whole body of the driver 50, an orientation in a horizontal direction and a front-back direction of the face, a direction of the line of sight, inclination of an upper body, and the like.

The seat belt detection function 24f has a function of detecting whether the driver 50 is wearing the seat belt.

The steering wheel holding detection function 24g has a function of detecting whether the driver 50 is holding the steering wheel in a state in which the driver 50 can drive.

The alarm function 25 has a function of supporting the safe driving of the driver 50 by notifying the driver 50 of an abnormality, for example, by outputting a voice or an alarm sound when any function of the monitoring function unit 24 detects a situation that should be warned regarding a driving state of the driver 50.

The history information recording function 26 records and stores, in a predetermined non-volatile recording medium as history information, the information detected by each of the functions of the monitoring function unit 24 regarding the driving state of the driver 50 in association with, for example, a current date and time and information on a current position of the vehicle.

The object detection control function 27 can generate a trigger so as to execute an object detection algorithm only when the action detection function 24d or the like in the monitoring function unit 24 detects that a specific condition indicating a high possibility of the distracted driving is satisfied. As will be described later, the object detection control function 27 identifies whether a specific condition is satisfied based on coordinates of a plurality of feature points detected by the feature detection function 21 regarding the image of the driver 50.

### Example 1 of Captured Image

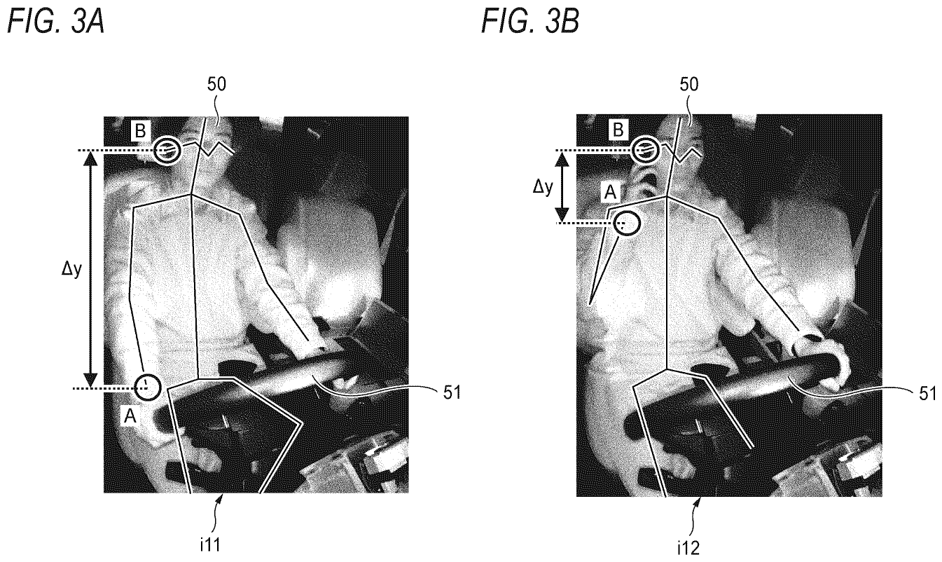

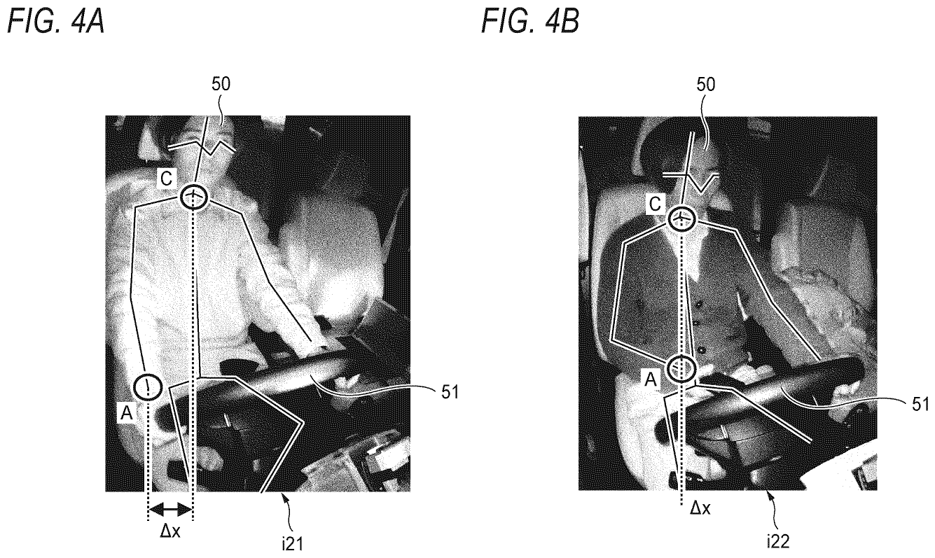

Two types of captured images i11 and i12 are shown in FIG. 3. Another two types of captured images i21 and i22 are shown in FIG. 4. In FIGS. 3 and 4, a horizontal direction is represented by an x axis and a vertical direction is represented by a y axis. Each position in the images is represented by two-dimensional coordinates of x and y.

In each of the captured images i11 and i12 shown in FIG. 3 and the captured images i21 and i22 shown in FIG. 4, information on the upper half body of the body, both hands, both arms, and the like of the driver 50 which is sufficient for grasping the driving situation is depicted.

In an example of the captured image i11 shown in FIG. 3, a situation is depicted in which the driver 50 is holding the steering wheel 51 with both the hands and driving in a safe state. In contrast, in an example of the captured image i12, a state is depicted in which the left hand of the driver 50 is holding the steering wheel 51, but the right hand is away from the steering wheel 51 and holds a smartphone close to a lateral side of the face, that is, a situation in which the driver 50 is driving while making a call.

In an example of the captured image i21 shown in FIG. 4, a situation is depicted in which the driver 50 is holding the steering wheel 51 with both the hands and driving in the safe state. In contrast, in an example of the captured image i22, a situation is depicted in which the left hand of the driver 50 is holding the steering wheel 51, but the right hand is away from the steering wheel 51 and holds the smartphone at a location away from the face, and the driver 50 is driving while either gazing at a screen of the smartphone or operating the screen.

In the captured images i11 and i12 shown in FIG. 3, a position of a feature point (A) in a wrist of the driver 50 and a position of a feature point (B) in an edge of the face (position of an ear) are shown.

It can be seen that in the captured image i11, a distance Δy in a y-axis direction between the two feature points (A and B) is relatively large. It can be seen that in the captured image i12, the distance Δy in the y-axis direction between the two feature points (A and B) is relatively small.

By examining a magnitude relation regarding magnitude of the distance Δy detected in the image, it is possible to easily distinguish between the safe driving state, as in the captured image i11, and a state in which a possibility of driving while making a call is high, as in the captured image i12.

Meanwhile, in the captured images i21 and i22 shown in FIG. 4, the position of the feature point (A) in the wrist of the driver 50 and a position of a feature point (C) in a neck are shown.

It can be seen that in the captured image i21, a distance Δx in an x-axis direction between the two feature points (A, C) is relatively large. It can be seen that in the captured image i22, the distance Δx in the x-axis direction between the two feature points (A, C) is relatively small.

By examining a magnitude relation regarding magnitude of the distance Δx detected in the image, it is possible to easily distinguish between the safe driving state, as in the captured image i21, and a state in which a possibility of driving while operating the smartphone is high, as in the captured image i22.

### Operation 1 of Main Control Unit

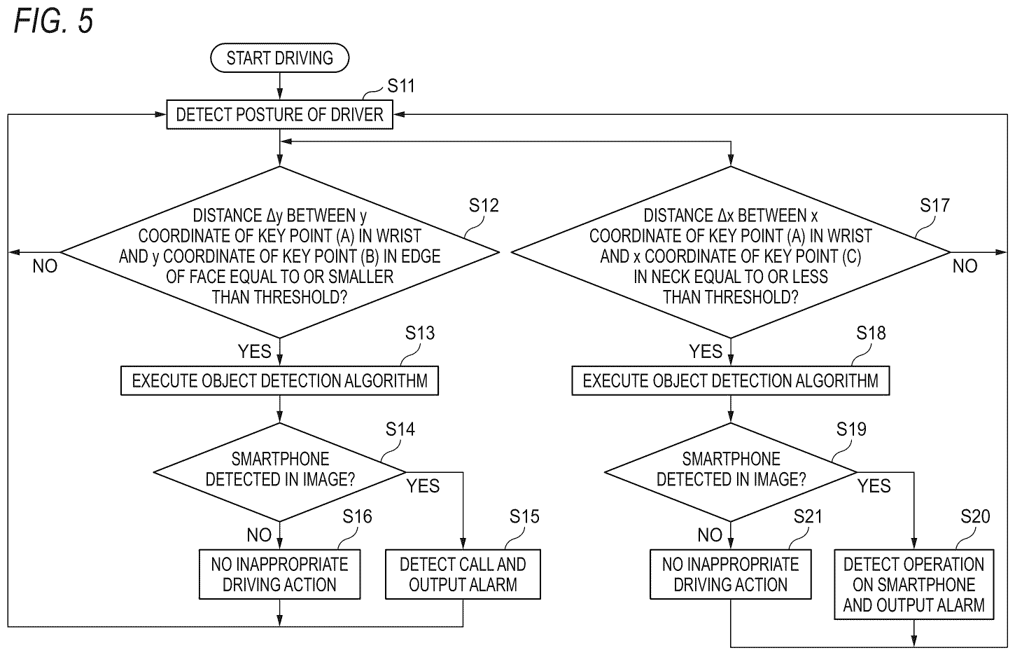

An operation example of the main control unit 20 is shown in FIG. 5. That is, the computer of the main control unit 20 starts the operation shown in FIG. 5 when a driver monitoring system (DMS) of the vehicle activates a function of monitoring the “distracted driving” performed by the driver 50. An operation shown in FIG. 5 will be described below.

The main control unit 20 periodically and repeatedly performs processing for detecting a driving posture of the driver 50 at short time intervals (S11). That is, image data of each frame captured by the first camera 10A is periodically input to the main control unit 20. The feature detection function 21 detects, for each frame, coordinate values of the feature points (A, B, and C) representing the posture of the driver 50.

The object detection control function 27 of the main control unit 20 acquires the coordinate values of the feature points (key point: A and B) from the feature detection function 21, calculates the distance Δy in the y-axis direction between the feature points (A and B), and compares the distance Δy with a threshold (S12).

For example, if the distance Δy is large as in the captured image i11 shown in FIG. 3, a condition in S12 is not satisfied. and thus the processing returns from S12 to S11. In contrast, if the distance Δy is small as in the captured image i12, the condition in S12 is satisfied, and thus the processing proceeds from S12 to S13.

The main control unit 20 starts execution of a predetermined object detection algorithm in S13 by a trigger output by the object detection control function 27. That is, in order to enable detection of an object such as a smartphone in addition to a feature point such as a joint of the driver 50, detailed image processing is performed, and processing such as pattern recognition of the object is also performed.

As a result of the object detection in S13, the main control unit 20 identifies whether the smartphone is detected in the image in S14.

If the smartphone is detected by the main control unit 20 in S14, the processing proceeds to S15. In S15, the main control unit 20 recognizes that the driver 50 is in the “distracted driving” state in which the driver 50 is making a call, and outputs an alarm for the “distracted driving.”

If the smartphone is not detected by the main control unit 20 in S14, the processing proceeds to S16. In S16, the main control unit 20 recognizes that the driver 50 is not in an inappropriate driving state even when the distance Δy is small.

The object detection control function 27 of the main control unit 20 acquires the coordinate values of the feature points (A and C) from the feature detection function 21, calculates the distance Δx in the x-axis direction between the feature points (A and C), and compares the distance Δx with a threshold (S17).

For example, if the distance Δx is large as in the captured image i21 shown in FIG. 4, a condition in S17 is not satisfied, and thus the processing returns from S17 to S11. In contrast, if the distance Δx is small as in the captured image i22, the condition in S17 is satisfied, and thus the processing proceeds from S17 to S18.

The main control unit 20 starts execution of the predetermined object detection algorithm in S18 by the trigger output by the object detection control function 27. That is, in order to enable detection of an object such as a smartphone in addition to a feature point such as a joint of the driver 50, detailed image processing is performed, and processing such as the pattern recognition of the object is also performed.

As a result of the object detection in S18, the main control unit 20 identifies whether the smartphone is detected in the image in S19.

If the smartphone is detected by the main control unit 20 in S19, the processing proceeds to S20. In S20, the main control unit 20 recognizes that the driver 50 is in the “distracted driving” state in which the driver 50 is operating the smartphone, and outputs the alarm for the “distracted driving.”

If the smartphone is not detected by the main control unit 20 in S19, the processing proceeds to S21. In S21, the main control unit 20 recognizes that the driver 50 is not in an inappropriate driving state even when the distance Δx is small. Therefore, in this case, the alarm is not output.

### Example 2 of Captured Image

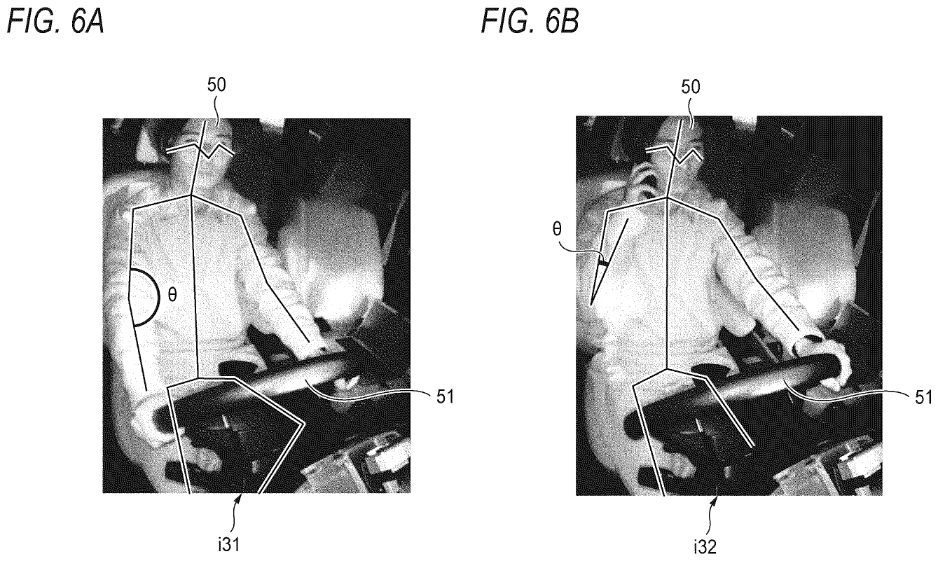

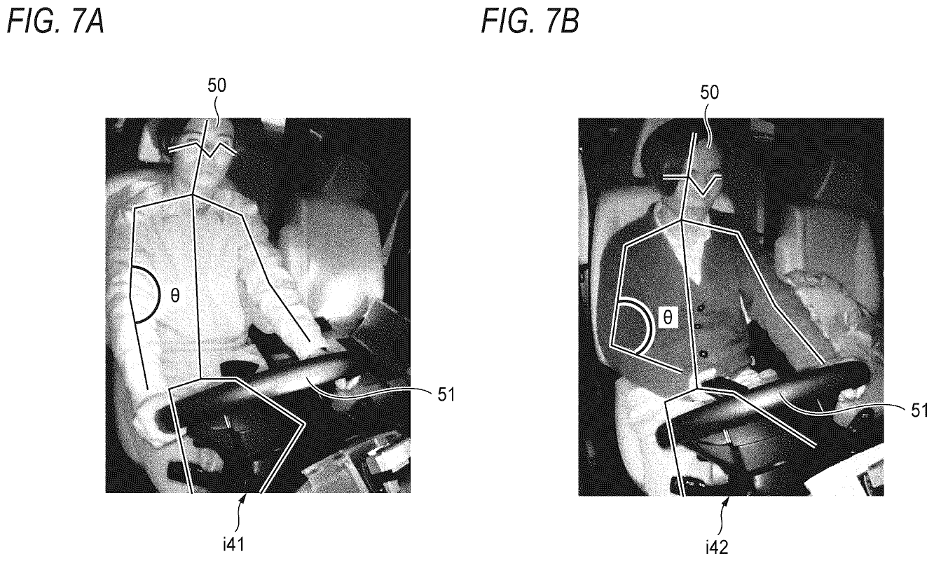

Two types of captured images i31 and i32 are shown in FIG. 6. Another two types of captured images i41 and i42 are shown in FIG. 7. In FIGS. 6 and 7, the horizontal direction is represented by the x axis and the vertical direction is represented by the y axis. Each position in the images is represented by two-dimensional coordinates of x and y.

In each of the captured images i31 and i32 shown in FIG. 6 and the captured images i41 and i42 shown in FIG. 7, information on the upper half body of the body, both the hands, both the arms, and the like of the driver 50 which is sufficient for grasping the driving situation is depicted.

In an example of the captured image i31 shown in FIG. 6, the driver 50 is holding the steering wheel 51 with both the hands, and thus it can be considered that the driver 50 is driving in the safe state. In contrast, in an example of the captured image i32, a state is depicted in which the left hand of the driver 50 is holding the steering wheel 51, but the right hand is away from the steering wheel 51 and holds the smartphone close to the lateral side of the face, that is, a problematic situation in which the driver 50 is driving while making a call.

In an example of the captured image i41 shown in FIG. 7, a situation is depicted in which the driver 50 is holding the steering wheel 51 with both the hands and driving in the safe state. In contrast, in an example of the captured image i42, a situation is depicted in which the left hand of the driver 50 is holding the steering wheel 51, but the right hand is away from the steering wheel 51 and holds the smartphone at a location away from the face, and the driver 50 is driving while either gazing at the screen of the smartphone or operating the screen.

In each of the captured images i31 and i32 shown in FIG. 6, a position of a feature point in a right wrist, a position of a feature point corresponding to a joint of a right arm, and a position of a feature point in a right shoulder of the driver 50 are depicted. An angle at a joint portion of the right arm which can be specified by the positions of the three feature points is indicated as θ.

Here, it can be seen that in the captured image i31, the angle θ at the joint portion of the right arm is large, whereas in the captured image i32, the angle θ at the joint portion of the right arm is small.

By examining a magnitude relation regarding magnitude of the angle θ at the joint portion detected in the image, it is possible to easily distinguish between the safe driving state, as in the captured image i31, and the state in which the possibility of driving while making a call is high, as in the captured image i32.

Meanwhile, in the captured images i41 and i42 shown in FIG. 7, the position of the feature point in the right wrist, the position of the feature point corresponding to the joint of the right arm, and the position of the feature point in the right shoulder of the driver 50 are depicted. The angle at the joint portion of the right arm which can be specified by the positions of the three feature points is indicated as θ.

Here, it can be seen that in the captured image i41, the angle θ at the joint portion of the right arm is large, whereas in the captured image i42, the angle θ at the joint portion of the right arm is small.

By examining the magnitude relation regarding the magnitude of the angle θ at the joint portion detected in the image, it is possible to easily distinguish between the safe driving state, as in the captured image i41, and the state in which the possibility of driving while operating the smartphone is high, as in the captured image i42.

### Operation 2 of Main Control Unit

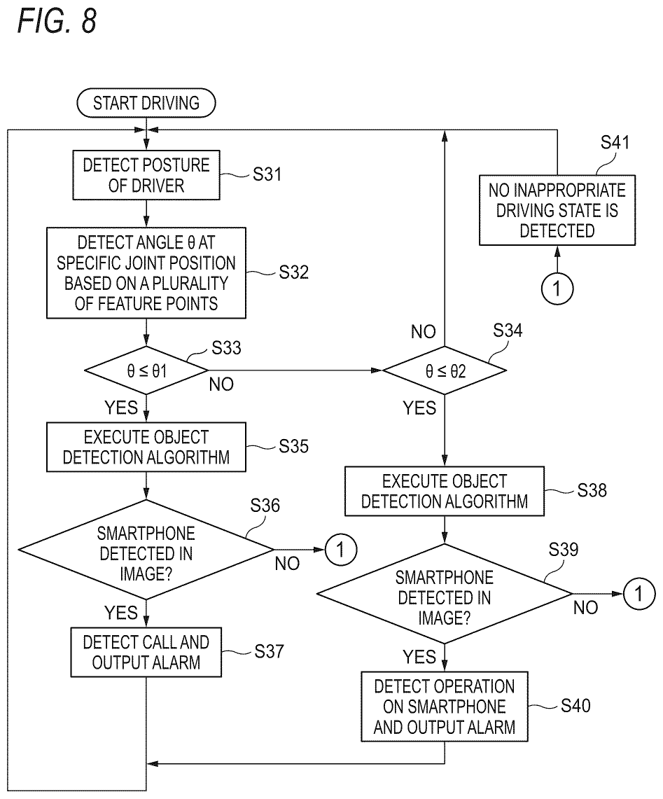

An operation example 2 of the main control unit 20 is shown in FIG. 8. That is, the computer of the main control unit 20 starts the operation shown in FIG. 8 when the driver monitoring system of the vehicle activates the function of monitoring the “distracted driving” performed by the driver 50. Control contents shown in FIG. 8 are designed assuming a case in which the images representing the situations such as the captured images i31 and i32 shown in FIG. 6 and the captured images i41 and i42 shown in FIG. 7 are processed. The operation shown in FIG. 8 will be described below.

The main control unit 20 periodically and repeatedly performs processing for detecting the driving posture of the driver 50 at short time intervals (S31). That is, the image data of each frame captured by the first camera 10A is periodically input to the main control unit 20. The feature detection function 21 detects, for each frame, coordinate values of the feature points (the position of the wrist, the position of the arm joint, and the position of the shoulder) representing the posture of the driver 50.

The object detection control function 27 of the main control unit 20 acquires the coordinate values of the feature points from the feature detection function 21, and calculates the angle θ at a joint position of the arm in S32. Then, the main control unit 20 compares the angle θ at the joint position with predetermined thresholds θ1 and θ2 (S33 and S34).

For example, if the angle θ at the joint position is large as in the captured image i31 shown in FIG. 6 or the captured image i41 shown in FIG. 7, conditions in S33 and S34 are not satisfied, and thus the processing returns from S33 to S31.

In contrast, if the angle θ at the joint position is equal to or smaller than the threshold θ1 as in the captured image i32, the condition in S33 is satisfied, and thus the processing proceeds from S33 to S35.

The main control unit 20 starts the execution of the predetermined object detection algorithm in S35 by the trigger output by the object detection control function 27. That is, in order to enable detection of an object such as a smartphone in addition to a feature point such as a joint of the driver 50, detailed image processing is performed, and processing such as the pattern recognition of the object is also performed.

As a result of the object detection in S35, the main control unit 20 identifies whether the smartphone is detected in the image in S36.

If the smartphone is detected by the main control unit 20 in S36, the processing proceeds to S37. In S37, the main control unit 20 recognizes that the driver 50 is in the “distracted driving” state in which the driver 50 is making a call, and outputs the alarm for the “distracted driving.”

If the smartphone is not detected by the main control unit 20 in S36, the processing proceeds to S41. In S41, the main control unit 20 recognizes that the driver 50 is not in the inappropriate driving state even when the angle θ at the joint position is small.

In contrast, if the angle θ at the joint position is larger than the threshold θ1 and equal to or smaller than the threshold θ2 as in the captured image i42, the condition in S34 is satisfied, and thus the processing proceeds from S34 to S38.

The main control unit 20 starts the execution of the predetermined object detection algorithm in S38 by the trigger output by the object detection control function 27. That is, in order to enable detection of an object such as a smartphone in addition to a feature point such as a joint of the driver 50, detailed image processing is performed, and processing such as the pattern recognition of the object is also performed.

As a result of the object detection in S38, the main control unit 20 identifies whether the smartphone is detected in the image in S39.

If the smartphone is detected by the main control unit 20 in S39, the processing proceeds to S40. In S40, the main control unit 20 recognizes that the driver 50 is in the “distracted driving” state in which the driver 50 is operating the smartphone, and outputs the alarm for the “distracted driving.”

If the smartphone is not detected by the main control unit 20 in S39, the processing proceeds to S41. In S41, the main control unit 20 recognizes that the driver 50 is not in the inappropriate driving state even when the angle θ at the joint position is small. Therefore, in this case, the alarm is not output.

The present invention is not limited to the embodiment described above, and can be appropriately modified, improved, or the like. In addition, materials, shapes, sizes, numbers, arrangement positions, or the like of components in the embodiment described above are freely selected and are not limited as long as the present invention can be implemented.

For example, for the “distracted driving” performed by the driver to be monitored by the driver monitoring device 100,
other than the operation on the smartphone, driving while eating, driving while smoking, and the like are also assumed. Therefore, for example, the object recognized in S13 and S18 in FIG. 5 and the object recognized in S35 and S38 in FIG. 8 may be modified to include food, drink, and cigarettes in addition to the smartphone. Even in a case in which the “distracted driving” caused by eating, drinking, or smoking is monitored, an influence of difference in a type of the target object on the distances Δx and Δy between the feature points and the angle θ at the joint is not largely different from that in the case of the smartphone, and thus the control contents shown in FIG. 5 and the control contents shown in FIG. 8 can be used as they are.

A combination of the processing shown in FIG. 5 and the processing shown in FIG.

8 may be used. That is, the main control unit 20 may detect both the distance Δx or Δy and the angle θ at the joint, and may perform control to proceed to any processing of S13, S18, S35, and S38 when either or both of the distance Δx or Δy and the joint angle θ satisfy a predetermined condition.

As described above, when the main control unit 20 of the driver monitoring device 100 executes the operation shown in FIG. 5, in a normal driving state in which the condition in S12 or S17 is not satisfied, it is sufficient to detect the coordinates of the plurality of feature points (A, B, and C), and it is not necessary to start the complex image processing to detect the object such as the smartphone.

When the main control unit 20 executes the operation shown in FIG. 8, in a normal driving state in which the condition in S33 or S34 is not satisfied, it is sufficient to detect the plurality of feature points and calculate the angle θ at the joint, and it is not necessary to start the complex image processing to detect the object such as the smartphone. Therefore, in either case of performing the control shown in FIG. 5 or FIG. 8, a load of the processing in the normal state in the main control unit 20 can be reduced. This makes it possible to reduce a cost of the main control unit 20, prevent heat generation, and extend a product life. Furthermore, an amount of power consumed by the main control unit 20 is also reduced.

Here, the features of the driver monitoring device and the monitoring program according to the embodiment of the present invention described above are briefly summarized and listed in the following [1] to [5].

[1] A driver monitoring device including:
an image acquisition unit (feature detection function 21) configured to acquire an image of a driver, and
a determination unit (action detection function 24d) configured to determine, based on the acquired image, whether the driver is using a predetermined detection target having no relation with a driving operation, in which
the determination unit extracts, from the image, a first feature point (B or C) included in a neck or a head of the driver and a second feature point (A) included in an arm or a hand of the driver, and performs processing (S12, S13, S17, and S18) of determining whether the detection target is included in the image when a difference (Δy or Δx) between a coordinate of the first feature point and a coordinate of the second feature point is smaller than a reference level.

According to the driver monitoring device having the configuration according to the above [1], it is sufficient to execute the simple processing of monitoring the coordinates of the two feature points or three feature points in the normal driving situation of the driver, and thus a processing load in the determination unit can be reduced. Only when it is detected that there is a possibility of the distracted driving based on the coordinates of the feature points, the processing for determining whether the detection target is included in the image is executed, whereby the situation of the distracted driving relating to a smartphone or the like can be detected.

[2] The driver monitoring device according to the above [1], in which
the determination unit determines whether the difference in one of an x coordinate and a y coordinate regarding the difference between the coordinate of the first feature point and the coordinate of the second feature point is smaller than the reference level (S12 and S17).

According to the driver monitoring device having the configuration according to the above [2], it is possible to identify, for example, two types of situations in the captured images i21 and i22 shown in FIG. 4 by comparing the difference (Δx) between the x coordinate of the first feature point and the x coordinate of the second feature point with the reference level. It is possible to identify, for example, two types of situations in the captured images i11 and i12 shown in FIG. 3 by comparing the difference (Δy) between the y coordinate of the first feature point and the y coordinate of the second feature point with the reference level.

[3] A driver monitoring device including:
an image acquisition unit (feature detection function 21) configured to acquire an image of a driver, and
a determination unit (action detection function 24d) configured to determine, based on the acquired image, whether the driver is using a predetermined detection target having no relation with a driving operation, in which
the determination unit detects at least three feature points including a point of a joint position of a body of the driver on the input image, calculates an angle (θ) at the joint position based on coordinates of these feature points, and performs processing of determining whether the predetermined detection target is included in the image when the calculated angle satisfies a predetermined condition (S32, S33, S34, S35, S38).

According to the driver monitoring device having the configuration according to the above [3], it is sufficient to execute the simple processing of detecting the coordinates of the three feature points and calculate the angle at the joint in the normal driving situation of the driver, and thus the processing load in the determination unit can be reduced. Only when it is detected that there is a possibility of the distracted driving based on the detected angle at the joint, the processing for determining whether the detection target is included in the image is executed, whereby the situation of the distracted driving relating to a smartphone or the like can be detected.

[4] The driver monitoring device according to the above [1], in which
the determination unit detects a mobile terminal in a vicinity of the hand of the driver as the detection target.

According to the driver monitoring device having the configuration according to the above [4], the mobile terminal that is likely to be handled by the driver during driving is detected, and thus even when the face or the line of sight of the driver is directed forward, it is easy to detect a situation in which the normal driving is not possible, as in the case of the inattentive driving.

[5] A monitoring program executable by a computer controlling a monitoring device, the monitoring device including an image acquisition unit configured to acquire an image of a driver, and a determination unit configured to determine, based on the acquired image, whether the driver is using a predetermined detection target having no relation with a driving operation, the monitoring program including:
a procedure (S11) of extracting, from the captured image, a first feature point included in a neck or a head of the driver and a second feature point included in an arm or a hand of the driver; and
a procedure (S12, S13, S17, and S18) of performing processing of determining whether the detection target is included in the image when a difference between a coordinate of the first feature point and a coordinate of the second feature point is smaller than a reference level.

According to the monitoring program having the configuration according to the above [5], it is sufficient to execute the simple processing of monitoring the coordinates of the two feature points or three feature points in the normal driving situation of the driver, and thus the processing load in the determination unit can be reduced. Only when it is detected that there is a possibility of the distracted driving based on the coordinates of the feature points, the processing for determining whether the detection target is included in the image is executed, whereby the situation of the distracted driving relating to a smartphone or the like can be detected.

The present application is based on a Japanese patent application (No. 2022-194327) filed on Dec. 5, 2022, the contents of which are incorporated herein by reference.

### Reference Signs List

10A: first camera

10B: second camera

20: main control unit

21, 22: feature detection function

23: timing control function

24: monitoring function unit

24a: inattention detection function

24b: drowsiness detection function

24c: posture collapse detection function

24d: action detection function

24e: posture detection function

24f: seat belt detection function

24g: steering wheel holding detection function

25: alarm function

26: history information recording function

27: object detection control function

50: driver

51: steering wheel

52: seat belt

100: driver monitoring device

A1, A2: imaging range

i11, i12, i21, i22, i31, i32, i41, i42: captured image

Δx, Δy: distance

θ: angle at joint portion

θ1, θ2: threshold

1. A driver monitoring device comprising:
an image acquisition unit configured to acquire an image of a driver; and
a determination unit configured to determine, based on the acquired image, whether the driver is using a mobile terminal in a vicinity of a hand of the driver, wherein
the determination unit extracts, from the image, a first feature point included in a neck or a head of the driver and a second feature point included in an arm or a hand of the driver, and determines that: the driver is operating the mobile terminal, when a difference of x coordinate, corresponding to a horizontal direction, between a coordinate of the first feature point and a coordinate of the second feature point is smaller than a first reference level, and when the mobile terminal is included in the image; and the driver is making a call, when a difference of y coordinate, corresponding to a vertical direction, between a coordinate of the first feature point and a coordinate of the second feature point is smaller than a second reference level, and when the mobile terminal is included in the image.

2. A driver monitoring device comprising:
an image acquisition unit configured to acquire an image of a driver, and
a determination unit configured to determine, based on the acquired image, whether the driver is using a mobile terminal in a vicinity of a hand of the driver, wherein
the determination unit detects at least three feature points including a point of a joint position of a body of the driver on the input image, calculates an angle at the joint position based on coordinates of these feature points, and determines that: the driver is making a call, when the angle is less than or equal to the first angle, and when the mobile terminal is included in the image; and the driver is operating the mobile terminal, when the angle is greater than the first angle and less than or equal to a second angle greater than the first angle, and when the mobile terminal is included in the image.
